(19) United States
(12) Patent Application Publication
(10) Pub. No.: US 2004/0038825 A1
(43) Pub. Date: Feb. 26, 2004

(54) Water soluble uv-protective coatings for biological pesticides and process for making same

(76) Inventors: Jarrod Ethan Leland, Cleveland, MS (US); Donald E Mullins, Blacksburg, VA (US); Larry Jay Vaughn, Christiansburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 10/344,374

(22) PCT Filed: Aug. 10, 2001
(86) PCT No.: PCT/US01/25193

(51) Int. Cl. A01N 63/00

(52) U.S. Cl. 504/117; 424/93.7; 424/93.6; 424/93.4

(57) ABSTRACT

The invention provides a formulation for the protection of a bioactive agent, a method of producing the formulation, and methods for using the formulation. In the formulation, the bioactive agent is coated with a water-soluble protective material, dried, and suspended in a hydrophobic carrier such as an oil. The formulation is used to deliver the bioactive to a target substrate. The bioactive agent may be a biopesticidal microbe, the protective material may be a lignin, and the target substrate may be an insect pest or plant.

### BACKGROUND OF THE INVENTION

1. Field of the Invention

The invention generally relates to methods and formulations for the protection of biologically active agents. In particular, the invention provides methods and formulations for the solar and thermal protection of biologically active pest control agents.

2. Background of the Invention

Reducing solar and thermal degradation of microbes and microbial propagules after their application to the environment is an important challenge to improving the performance of these agents for environmental manipulation, particularly in the realm of plant protection products. For example, biopesticides, whose active agent is usually a pathogen of the target organism, must persist in the environment long enough to contact and infect the target organism. Likewise, biologically active products whose agents act as antagonists to disease organisms (e.g. a non-virulent superior competitor against an organism that causes a plant disease), may benefit from protection against solar or thermal degradation during the early colonization phase of the soil or a plant surface. Many different approaches have been taken in order to overcome this solar and thermal degradation, including varying the formulation of a product by the addition of protective agents and manipulating microbial physiology. Oil-based formulations of microbial biopesticides provide some advantages over water-based formulations. For example, oil based formulations are compatible with ultra-low volume (ULV) application, which is particularly important in pest control situations where delivering a minimum amount of material to the target site is an advantage. Further, oil based formulations allow a microbial biopesticide to remain dehydrated, which can help protect the active agent, as in the case of increased thermal stress tolerance of entomopathogenic fungi (McClatchie et al., 1994). Oil based formulations may also increase the ability of the biologically active agent to adhere to and disperse over hydrophobic surfaces (Bateman et al., 1993; Prior et al., 1988). They may also disrupt the waxy layer of insect cuticle, enhancing the infectivity of contact biopesticides such as entomopathogenic fungi.

Ultraviolet (UV) light is known to be a major source of damage to bioactive agents that are exposed to sunlight. Researchers have attempted to protect microbial biopesticides from TV light, particularly high energy UVB wavelengths (280-320 nm). Sun screens and sun blockers have been used to protect Metarhizium fungal spores in oil based formulations, but with only mixed success (Hunt et al., 1994). This may be due to the fact that when oil-based formulations are sprayed, they tend to spread out over the typically hydrophobic surface of the target substrate (such as plant leaves, or the exoskeleton of an insect). This property is good in that the formulation tends to become distributed over and adhere to the target surface. However, as the formulation spreads over the surface of the substrate, the protective layer of oil that surrounds the bioactive agent thins and the bioactive agent becomes exposed. The effect is particularly pronounced on hydrophobic surfaces, which discourage beading of oil droplets. This phenomenon may help explain why some sun screens perform well in published laboratory assays that are carried out on glass (which is relatively hydrophilic and causes “beading” of the oil droplets) but do not perform as well in field trials on natural hydrophobic surfaces (Burgess, 1998).

The greater success of UV-protectants in water-based formulations compared to oil-based formulations has been attributed to the large contact angle on hydrophobic surfaces and the concentration of UV-protectants upon evaporation (Burgess, 1998). Unlike oil-based formulations, droplets of aqueous formulations form a large contact angle with hydrophobic surfaces, providing a relatively “thick” layer of protection. In addition, as the water droplet evaporates, the UV-blockers or absorbers are concentrated, increasing protection of microbial biopesticides contained within the droplets (U.S. Pat. No. 5,750,467 to Shasha et al.). However, aqueous-based formulations have the disadvantages of not spreading over hydrophobic surfaces, non-adherence to hydrophobic surfaces, and non-disruption of cuticular waxy layers of insect targets. Also lost with aqueous formulations are possible advantages of thermohydric stress reduction (McClatchie et al, 1994) and reduced formation of reactive oxygen intermediates (Cooper and Zika, 1983; Ignoffo and Garcia, 1978).

It would be highly desirable to have oil-based formulations of bioactive agents and methods for their use that provide the bioactive agent with a high degree of protection from solar and thermal degradation.

### SUMMARY OF THE INVENTION

It is an object of this invention to provide novel protective formulations of bioactive agents and methods for their use. The formulations and methods combine advantages of both water-based and oil-based systems previously known in the art. In the formulations, a biologically active agent is first mixed with a water-soluble protective coating and dried. The dried, coated agent is then suspended in a hydrophobic carrier, such as an oil for application to a target substrate. When such a formulation is applied to a target substrate, the oil component facilitates dispersal of the formulation over the substrate and adherence of the formulation to the substrate. Without being bound by theory, it is believed that, as the oil disperses, the coated agent particles may become exposed as in other oil-based methods. However, the water-soluble protective outer coating carried by the particles remains in contact with the active agent intact both while suspended in the oil (the coating material is not soluble in oil), and later on the surface of the substrate as the oil disperses. Because the protective outer coating is water-soluble, the bioactive agent is eventually released from the coating upon exposure to water in the environment, e.g. from water that is present on the target substrate. However, until such water is available, the coated bioactive agent remains protected from environmental insults (e.g. heat, solar radiation, and the like) by the protective coating.

It is an object of the instant invention to provide novel formulations comprising a bioactive agent coated with water-soluble protective material in a hydrophobic carrier. The coated bioactive agent is produced by being combined in an aqueous mixture with the water-soluble protective material (and optionally with stabilizers). The mixture is then dried, and the dried mixture is suspended in the hydrophobic carrier, which may be an oil or a mixture of several oils.

The bioactive agent may be any agent that is capable of acting on a biological entity and producing a desired effect in the biological entity. For example, the bioactive agent may be a biopesticidal microbe (such as a fungus, a virus, a protozoan, or a bacterium), an antagonist to a disease-causing organism, or a microbe that otherwise promotes plant growth or health. The bioactive agent may be a nematode. The bioactive agent may be a toxin and/or insect feeding inhibitor, such as known substances produced by the bacterium Bacillus thuringiensis, substances produced by plants such as Azadirachta indica or Melia volkensii, or synthetic chemicals. The bioactive agent may be natural insect pheromones or their synthetic analogues. The bioactive agent may be an insect growth regulator—a group of chemicals generally recognized by practitioners of the art having a mode of action that inhibits normal developmental processes in immature insects without killing the insect through direct toxicity.

The water-soluble protective material that coats the bioactive agent may be any material that is useful for protection of the bioactive agent Examples of such protective materials are those that protect against damage from UV light (UV protectants such as sun screens and sun blockers), and materials that provide thermal protection, or the stabilizing of biological materials in a desiccated state. In some cases, a single material may provide more than one protection.

The invention provides a method of exposing a target substrate to a bioactive agent by contacting the target substrate with the formulation of the instant invention. Exemplary target substrates include insects and plants. In a preferred embodiment of the instant invention, the target substrate is an insect pest and the bioactive agent is a biopesticidal microbe.

### BRIEF DESCRIPTION OF THE DRAWINGS

FIG. 1. Colony-forming units (log 10 CFU's) for four formulations after exposure to UVB. Each data point represents four replicate plates from one replicate of each treatment.

FIGS. 2 A-D. Average adult desert locust Schistocerca gregaria mortality over time for four formulations of Metarhizium anisopliae var. acridum fungal spores. Mortality is corrected for control mortality by Abbott's formula. Each data point represents two replicate cages of ten insects. 3A: 1×10³ spores/insect; 3B: 1×10⁴ spores/insect; 3C: 1×10⁵ spores/insect; 3D: 1×10⁶ spores/insect.

FIG. 3. Germination over time for liquid culture spores (LCS) and aerial culture spores (ACS) in five suspension medias.

FIG. 4. Germination over time for liquid culture spores (LCS) and aerial culture spores (ACS) with five different coatings after drying. (data not shown for ACS-3,13 hr.).

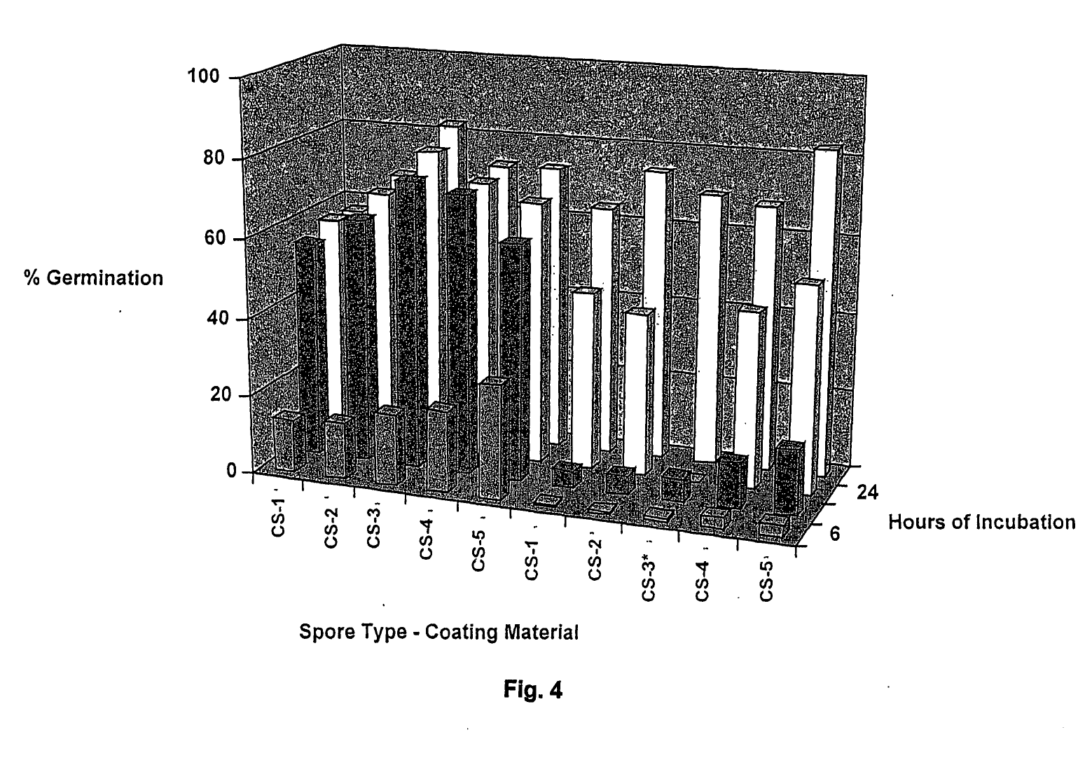

FIG. 5. Viability of liquid culture spores (LCS) as percentage germinating at 42 h of incubation after drying and sieving.

FIG. 6. Germination over time for liquid culture spores (LCS) and aerial culture spores (ACS) with five different coatings after drying and storage for six days at 28° C.

FIG. 7. Percent germination of spores following different periods of UV exposure (48 hr incubation on 2% malt agar+Benlate). NAC=non-coated aerial culture; CAC=coated aerial culture; CLC=coated liquid culture.

FIGS. 8. A-D. Average adult Schistocerca americana mortality over time for three formulations of Metarhizium anisopliae var. acridum fungal spores. Mortality is corrected for control mortality by Abbott's formula Each data point represents ten individually caged insects. 3A: 1×10³ spores/insect; 3B: 1×10⁴ spores/insect; 3C: 1×10⁵ spores/insect 3D: 1×10⁶ spores insect.

### DETAILED DESCRIPTION OF THE PREFERRED EMBODIMENTS OF THE INVENTION

The present invention provides formulations comprising a bioactive agent. By “bioactive agent” we mean that the agent is capable of exerting an effect on a living, biological entity. Examples of such living, biological entities include but are not limited to plants, insects, protozoa, fungi, algae, bacteria, nematodes, molluscs, and the like. Those of skill in the art will recognize that many biological entities exist for which it would be beneficial have the capability to target and effect using the formulations and methods of the instant invention, and all such biological entities may be targeted and treated by the formulations and methods of the instant invention, i.e. they are “target substrates” for the bioactive agent. Further, these biological entities may be targeted at any suitable stage of their life cycle, e.g. adult or immature stages such as caterpillars, larvae, nymphs, eggs, pupae, and the like. Further, a “target substrate” may include either the living entity itself, or its habitat.

The formulations and methods of the instant invention are capable of exerting a desired effect on or eliciting an effect from a targeted biological entity. The types of effects that may be elicited include but are not limited to death, cessation of feeding, delayed development, inability to reproduce, inhibition of growth, increase in growth, and the like. Those of skill in the art will recognize that many different types of effects exist which it may be desirable to elicit by utilizing the formulations and methods of the present invention, and all such are intended to be encompassed by the instant invention.

In a preferred embodiment of the instant invention, the biological entity that is targeted by the formulations and methods of the instant invention is an insect pest or a noxious or undesirable plant (e.g. a “weed”), and the effect that is elicited is death of the insect pest or weed. For example, the formulation may an insecticide and the bioactive agent may be specific for destroying insects. In yet another preferred embodiment, the biological entity that is targeted is a disease producing organism, or a host or vector of a disease producing organism (e.g. mosquito, ticks, flies and the like).

The formulations of the instant invention comprise a bioactive agent for which it would be beneficial to provide a water-soluble protective coating. The reason for providing such a protective coating may be to protect the bioactive agent from environmental insults such as heat, solar radiation, exposure to chemicals, and the like. Those of skill in the art will recognize that many such bioactive agents exist, examples of which include but are not limited to microbiocidal agents, biopesticidal microbes, viruses, nematodes, toxins, insect feeding inhibitors, pheromones, growth regulators, and the like. In addition, in a preferred embodiment of the present invention, the bioactive agent itself is a biological entity. Examples of such bioactive biological entities include but are not limited to microbes such as fungi, bacteria, viruses, protozoa, nematodes, and the like. In a preferred embodiment of the instant invention, the bioactive agent is a biopesticidal microbe, for example, a bacterium, fungus, protozoan, or virus. In addition, a bioactive biological entity may be at any suitable stage of its life cycle when utilized in the practice of the present invention. For example, in a preferred embodiment of the instant invention, the bioactive agent is a fungal spore. Further, the bioactive biological entities may be genetically engineered, as in, for example, a microbe that has been genetically engineered to produce a protein that is either beneficial to or harmful to the targeted entity.

In the formulations of the instant invention, the bioactive agent is coated with a water-soluble protective coating. In a preferred embodiment of the instant invention, the protective, water-soluble coating is comprised of UV-protective material. The water-soluble coating may protect the biologically active agent by absorbing, blocking, or reflecting UV radiation, or by negating active oxygen radicals. In addition to protecting the biologically active agent from UV light, the coating material must also have the property of being highly water-soluble, such as Kraft lignins or lignosulfonates. Those of skill in the art will recognize that many such suitable UV-protective materials exist which may be utilized in the practice of the present invention, and all such materials are intended to be encompassed by the instant invention.

In a preferred embodiment of the instant invention, the water soluble protective coating comprises lignin or a lignin derivative. By “a lignin” or “a lignin derivative” we mean any polymers commonly understood by those practiced in the art to have the general chemical characteristics of lignin and any molecules modified from lignin. Lignins are extracted from plant material by physical or chemical degradation of the plant material such as by steam explosion or enzymatic degradation. The lignins can be rendered water-soluble by chemical modification such as by the Kraft process, reaction with a strong base followed by a strong acid to form a salt, or by the addition of a strong base followed by carbon dioxide to reduce the lignin pH. The UV protective qualities of lignin have been known for many years. Since the 1970's several patents have described how lignins may be used as adhesion agents, for UV protection, and for controlled release in chemical pesticide formulations (U.S. Pat. Nos. 4,184,866, 4,244,728 and 4,244,729 to Dellicolli et al.; U.S. Pat. No. 4,948,586 to Bohm et al.; and U.S. Pat. Nos. 5,529,772 and 5,552,149 to Lebo). U.S. Pat. No. 5,750,467 to Shasha et al. (incorporated herein by reference in its entirety) describes a lignin-based UV protective formulation for biopesticides. The aforementioned patent provides a method for applying microbial pesticides in aqueous formulations with a lignin derivative that is linked with a multivalent salt. As droplets of the formulation evaporate, the water-soluble lignin likely cross-links with cationic sights on a multivalent salt via the anionic cinnamyl alcohol residues of the lignin molecules. Upon drying, the cross-linked lignin forms a protective coating on the microbial pesticide particles.

Lignins possess excellent and well-known UV-protective qualities, they may be rendered water soluble by methods which are well-known to those of skill in the art, and they are relatively inexpensive and readily available since they are waste products of the paper pulp industry. Those of skill in the art will recognize that many means to render lignin water soluble exist, including but not limited to the Kraft process, extraction with a strong base followed by a strong acid, and extraction with a strong base followed by neutralization with carbon dioxide. Water-soluble derivatives produced by such means may be utilized in the practice of the present invention, so long as they have a useful pH range. By “useful pH range”, we mean a pH range at which the lignin derivatives remain water soluble and which is tolerated by the bioactive agent, i.e. at which the bioactive agent retains its ability to have the desired effect on a targeted biological entity. This pH range may also enhance the activity of a microbial control agent (e.g. Bacillus thuringiensis crystals or nuclear polyhedrosis virus) by buffering the negative effects of high pH environments that may be found, for example, on certain plant surfaces or in the gut of target insects. In preferred embodiments of the instant invention, the lignin derivatives that are utilized are a cationic lignin (Curan 100, a Kraft alkali lignin, Aldrich #37-095-9) and an anionic lignin (Ultrazine, a sodium salt of a lignosulfonic acid, Aldrich #37-097-5). For a discussion of lignin chemistry and derivatization, see U.S. Pat. No. 5,750,467 to Shasha et al.

The bioactive agents of the instant invention are coated with a protective, water-soluble coating. Particles of the bioactive agent may be coated with the protective material by any of several means that are well-known to those of skill in the art. In general, the bioactive particles are mixed with the protective, water-soluble material in an aqueous-based medium and then dried.

In addition, various other compounds may be added to the bioactive agent-protective material mixture prior to drying. For example, additional stabilizers such as skim milk; various biologically compatible solutes (e.g. polyols) that function in osmoregulation and can protect macromolecules such as proteins (Brown, 1976; Crowe et al., 1990); non-reducing sugars (e.g. disaccharides such as trehalose) which have the ability to stabilize membranes (Crowe et al., 1984, 1990) and enzymes (Carpenter and Crowe, 1998, a, b); antioxidants (e.g. ascorbic acid and propyl gallate (Ignoffo and Garcia, 1994), salts, buffering agents, coloring agents, and the like may be added. Those of skill in the art will recognize that biologically compatible solutes form a distinct category of compounds that may be utilized in the art in order to stabilize or protect substances during the drying process, or to otherwise facilitate the drying process.

Further, the formulations of the present invention may contain more than one type of bioactive agent in a single formulation.

Drying of the aqueous bioactive agent-protective material mixture may be carried out by any of many methods which are well-known to those of skill in the art, including but not limited to air drying, counterflow towers, freeze drying, spray drying, fluidized bed drying, and the like. Any method of drying may be utilized in the practice of the instant invention, so long as the bioactive agent remains viable and the protective coating is adequately adhered to the bioactive agent In a preferred embodiment, the mixture is air dried.

After drying, the particle size of the dry material may be reduced and/or standardized to form a dispersible mixture, or the particle size of the final product may be determined by parameters in the drying process, particularly in the case of spray drying. Preferable methods of size reduction and standardization include grinding, sieving, and pulverizing. As will be recognized by those of skill in the art, the desired size of the particles is dependent on the application requirements. For example, for ultra-low volume application, the particle size must be less than 100 micrometers in diameter.

In the formulations of the instant invention, the coated, bioactive agent is suspended in a hydrophobic carrier such as oil. Those of skill in the art will recognize that many suitable hydrophobic carriers exist which can be utilized in the instant formulations, including but not limited to the many types of refined and unrefined vegetable and mineral oils. Any suitable type of oil may be utilized in the practice of the present invention, so long as the oil does not dissolve the protective coating, is not toxic to the bioactive agent, and has viscosity suitable for the application method. In addition, the carrier may be comprised of a mixture of such hydrophobic components, e.g. a mixture of oils which may include, for example, a petroleum distillate, mineral oils, or vegetable oils. For example, for ultra-low volume applications a low viscosity oil such as diesel fuel or kerosene may be mixed in adequate proportions with higher viscosity oils such as peanut oil, sunflower oil, corn oil, or any other suitable naturally occurring or synthetic oil. Further, the hydrophobic carrier may contain various additives such as stabilizers, detergents, and the like.

The oil formulation is then applied to a target substrate. The formulation may be applied directly to the target (e.g. an insect pest, or the leaf of a plant) or indirectly by applying the formulation to an area to which the targeted entity will be exposed (e.g. a crop, or the habitat of an insect pest). Examples of potential areas for application include but are not limited to seeds, crops, fields, soil, bare ground, dwellings, building structures, bodies of water, marshes, forests, brush, and the like. Those of skill in the art will recognize that the formulation of the present invention may be applied to any substrate so long as the targeted biological entity is eventually contacted by the formulation (either by direct application of the formulation, or indirectly by contact with an area to which the formulation has been applied.) Formulations of this type are typically applied by spraying, although those of skill in the art will recognize that any suitable method may be utilized The exact type and manner of spraying may vary from situation to situation, depending on factors such as the type of target, general environmental conditions, amount of formulation to be applied, cost, and the like. Any suitable means of spraying or otherwise applying the formulation of the instant invention may be utilized in the practice of the instant invention. Further, the concentration of bioactive agent in the formulation will vary depending on several factors, including but not limited to the nature of the bioactive agent itself, and the type and means of administration of the formulation. For example, for ULV application of M. anisopliae var. acridum spores, an application rate of 2×10¹²-2×10¹³ spores/ha has been recommended (Kpindou et al., 1997 ; Lensen, 1999). Spores are applied in a volume of 0.5-2 L/ha depending on the particular sprayer used (Lomer et al., 1997). Thus, the concentration of spores would need to be between 1×10⁹ and 4×10¹⁰ spores/mL of total liquid formulation. Those of skill in the art are well acquainted with such determinations.

The following examples serve to illustrate various embodiments of the instant invention, but should not be construed so as to limit the invention in any way.

### EXAMPLES

Materials and Methods

Curan 100 and Ultrazine are two commercially available lignin derivatives (Aldrich Chemical Co. catalog numbers #37-095-9 and #37-097-5, respectively). Both of these products are extracted from wood by steam-explosion followed by chemical extraction. Curan 100 is a Kraft alkali lignin and Ultrazine is a sodium salt of a lignosulfonic acid.

Production of Fungal Spores

Submerged spores were produced in a 1-L BioFlo III System (New Brunswick Scientific). The liquid media consisted of 40 g/L waste brewers' yeast and 40 g/L fructose (Sigma). Waste brewers' yeast was harvested from a batch of Stroh's beer by NPC incorporated (Eden, N.C.). The pH of the media was adjusted to 7.0 with sterile 1 N, NaOH before autoclaving. Aerial conidia of Metarhizium anisopliae var. acridum (IMI 330189) from Sabouraud dextrose agar was used as an inoculum. Conidia were harvested by scraping 2-3 week old cultures and suspending in 0.05% Tween 80 in sterile distilled water. Conidia densities were determined by hemacytometer and adjusted to 6×10⁶ conidia/mL. Viability of the inoculum was determined as percent germination after 24 hr at 24° C. on 2% malt agar. Media was inoculated to produce an initial concentration of 1.2×10⁵ spores/mL of media Temperature in the 1-L fermenter was maintained at 24° C. The air-flow rate was 0.5 L/min (0.5 VVM). The minimum dissolved oxygen was set at 0.5% of saturation and was maintained by allowing the agitation rate to automatically adjust between 130 RPM and 500 RPM. Antifoam 289 was delivered by automatic delivery system that monitored foaming. The contents of the bioreactor was sampled approximately every 5 hours, at which time the dissolved oxygen, temperature, and agitation rate were recorded. The final spore concentration after 5 days was determined by hemacytometer to be 8.2×10⁸ spores/mL.

### Example 1

Microbe Viability During Production of Formulation (Coating by Freeze-Drying)

This example demonstrates that an entomopathogenic fungus, Metarhizium anisopliae var. acridum, remains viable during production of the formulation. Spores from submerged culture were washed three times by centrifugation and resuspending in 0.05% Tween 80 (2800×G, Fisher Scientific Marathon 6K centrifuge). The washed spores were divided into three equal portions. Three different prelyophilization solutions were added to the three portions (10% skim milk, 1% glycerol; 10% Curan 100, 1% glycerol; and 10% Ultrazine, 1% glycerol). The volume of each prelyophilization solution added to the washed spores was 20 mL, which was approximately equal to the volume of each pellet, for a total volume of 40 mL. The spores were suspended in the prelyophilization solutions and then immediately frozen at −80° C., and lyophilized.

After lyophilation, samples were gently ground to a particle size of less than 126 μm using grinding and sieving. The concentration of spores/g of freeze dried material was determined by direct cell counting of an aqueous suspension of weighed material. Viability at each step in the formulation process was determined by incubating aqueous spore suspensions on 2% malt agar for 24 hr and observing percent germination of spores for 200 spores at 200× magnification. The results appear in Tables 1 and 2.

Table 1 shows the viability of spores after specific steps in the formulation process and the final concentration of spores (spores/g of lyophilized material). Table 2 shows the concentration of spores in the lyophilized material and an estimate of the number of spores corresponding to each particle in the lyophilized formulation.

Results show that submerged spores of Metarhizium anisopliae var. acridum were able to survive the coating process in the presence of skim milk, Curan 100™ and Ultrazine™. Survival rates ranged from 83-91%. In contrast, survival of lyophilized uncoated submerged spores was poor (13%). Each of the lyophilized samples produced a solid block that was easily broken into a fine powder. The particle size of this powder was easily reduced to less than 120 μm by grinding the material against the surface of a metal sieve with a rubber spatula. The concentration of spores within the lyophilized powder is very high, ranging from 5×10⁹ to 7×10⁹/g of dry powder and is well within the necessary range for, for example, ULV application.

This example demonstrates that a biological bioactive agent remains viable during the process of being coated with protective material as described in the instant invention, and that the agent is present in useful quantities in the dried, protective material.

TABLE 1
Germination Rate in Lyophilized Mass after 24 hours.

| | Viability After | Viability |
|---|---|---|
| | Lyophilization | After Sieving |
| Treatment | (% germination) | (% germination) |
| Skim milk | 91 | 88 |
| Curan 100 ™ | 83 | 71 |
| Ultrazine ™ | 86 | 63 |
| No Protection | 13 | n/a |

TABLE 2
Concentration of Spores in Final Formulation

| | Spore | Particle | |
|---|---|---|---|
| | Concentration in | Concentration in | Average Spore |
| | Lyophilized | Oil Formulation | Concentratioin |
| | Powder | (particles/mL) at | (spores/ |
| Treatment | (spores × 10⁹/g) | 5 × 10⁷ spores/mL | particle) |
| Skim milk | 4.9 | 4.6 × 10⁶ | 11 |
| Curan 100 ™ | 7.0 | 6.7 × 10⁶ | 7 |
| Ultrazine ™ | 6.3 | 6.8 × 10⁶ | 7 |

### Example 2

UV Protection (Freeze-Dried Product)

This example demonstrates that the formulations with coated spores in an oil carrier protect spores from damage by UV radiation. Submerged spores were lyophilized with three different aqueous solutions (treatments 1-3): 10% skim milk plus 1% glycerol; 10% Curan 100™ plus 1% glycerol; and 10% Ultrazine™ plus 1% glycerol as described in Example 1. Aerial conidia, which were used as a reference in this experiment, were harvested from 20-day old plate cultures on Paris medium. Briefly, the procedure consisted of depositing test inocula, coated spores, or crude aerial conidia on membrane filters; exposing dried and sealed membrane filters to radiation, and recovering irradiated inocula from the filters.

A 70-mL suspension of 1×10⁷ spores/mL of 70% diesel fuel: 30% peanut oil, was prepared for each treatment. The concentration of aerial conidia (treatment 4) was determined using direct hemacytometer counting. The propagule concentration for the lyophilized material was based on mass of lyophilized material and a predetermined spore concentration (spores/g of lyophilized material). For each treatment 10 mL of 1×10⁷ spores/mL were deposited onto a 0.45 μm membrane filter (ME25 Schleicher and Schuell, Dassel, Germany). Deposition onto the filter was done using a Millipore vacuum filtration system (Millipore 10-047-04, 10-047-02). The total area of the inoculum deposit using this system is 10 cm². Six membrane filters were prepared for each treatment.

Laboratory irradiation experiments consisted of exposing the dried fungal formulations on the membrane filters to broad wavelengths greater than 295 nm, at increasing amounts of time. Irradiation tests were conducted in a controlled environment chamber using an artificial sunlight device. The artificial sunlight device consisted of two 400 W high pressure metallic halogen lamps (HQI-TS, OSRAM, F67120, Molsheim, France), which emit a continuous spectrum from 270 to 1100 nm. A long pass glass filter (WG295-Schott Glaswerke, Mainz, Germany) was used to block shorter wavelengths (under 295 mm) to simulate natural sunlight. One propagule-seeded filter membrane from each treatment type was exposed to UV irradiance of 0.585 W m⁻² for 0, 4, 8, 12 or 16-hours. These exposures correspond to UV irradiances of 0, 4.32, 8.46, 12.78, and 17.10 kJ m⁻², respectively.

Shaded propagule-seeded membrane filters were used as controls for each of the different formulations. One membrane was covered with a metal plate to block radiation and placed in the controlled environment chamber for 16 hr. During the exposure period, the surface temperature of the seeded surface of membrane filters was regulated at 25±1° C. and the air humidity ranged from 40 to 50% relative humidity (RH). After exposure, spores were removed from the filter by placing the membrane in 10 mL of sterile distilled water (also containing 15-μL Tween 80) in 25-mL flasks and then shaking the flasks for 5 minutes at 700 oscillations min⁻¹ (10 cm vertical travel) on a mechanical shaker.

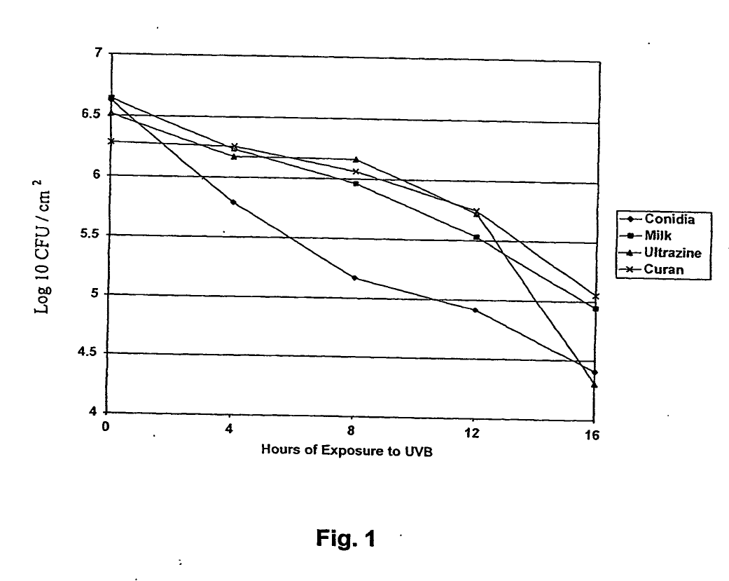

Percent germination was determined for a suspension of 1×10⁶ spores/mL on Paris medium. Estimates of germination rate were based upon examination of 200 spores at 320× on duplicate plates after 24 and 48 hours at 25° C. A single plate was scored for each treatment/exposure combination. Controls and treatments exposed for 4 hr of UV had grown enough to check germination after 24 hr. All other treatments required 48 hr to produce enough growth to distinguish germination. In addition, colony-forming units (CFUs) were determined for suspensions of irradiated spores on four replicate Paris media Petri plates using a spiral plating method. The spore suspension used for CFU counts was approximately 3.3×10⁵ spores/mL before the spiral plating. After 4 days of incubation in the dark at 25°±1° C., colonies were enumerated on three consecutive days to ensure that CFU's accounted for delayed growth. The results of this experiment are presented in Tables 3 and 4 and FIG. 1.

Two criteria were used to examine the viability of M. anisopliae var. acridum spores after exposure to UVB, percent germination and colony forming units (CFU's). Viability estimates based on CFU's depend upon percent recovery of spores from the membrane filter, whereas viability estimates based on percent germination are not. The results demonstrate greater UV stability for the lyophilized formulations than for fresh aerial conidia Coating of the spores appears to provide significant UV protection, and the two lignin formulations appear to provide greater UV protection than skim milk coating.

TABLE 3
Percent Germination of Spores in Four Formulations
after Varying Lengths of Exposure to UVB

| | % Germination | | | | | |
|---|---|---|---|---|---|---|
| | (% ÷ t = germination) | | | | | |
| | 0 hr | 4 hr UV | 8 hr UV | 12 hr UV | 16 hr UV | 16 hr |
| Treatment | (control) | exposure | exposure | exposure | exposure | (control) |
| Aerial conidia | 95 | 44 | 7 | 3 | 0 | 92 |
| | (100) | (46) | (8) | (3) | (0) | (97) |
| Milk-coated | 88 | 33 | 55 | 13 | 11 | 74 |
| | (100) | (38) | (62) | (15) | (13) | (84) |
| Curan100 ™ | 77 | 35 | 42 | 32 | 18 | 53 |
| coated | (100) | (45) | (55) | (42) | (23) | (68) |
| Ultrazine ™ | 63 | 41 | 43 | 25 | 18 | 50 |
| coated | (100) | (65) | (68) | (40) | (29) | (80) |

TABLE 4
Colony-forming Units after Varying Lengths of Exposure to UVB

| | Viability (CFU × 10⁶/cm²) | | | | | |
|---|---|---|---|---|---|---|
| | 0 hr | 4 hr UV | 8 hr UV | 12 hr UV | 16 hr UV | 16 hr |
| Treatment | (control) | exposure | exposure | exposure | exposure | (control) |
| Aerial | 4.2¹ | 0.62 | 0.15 | 0.083 | 0.026 | 4.9 |
| conidia | | | | | | |
| Milk-coated | 4.5 | 1.7 | 0.91 | 0.34 | 0.088 | 4.4 |
| Curan 100 ™ | 1.9 | 1.8 | 1.2 | 0.56 | 0.11 | 2.1 |
| coated | | | | | | |
| Ultrazine ™ | 3.3 | 1.5 | 1.5 | 0.53 | 0.02 | 2.4 |
| coated | | | | | | |

¹The number of colony forming units is based on four replicate plates. Each exposure time/formulation treatment combination was performed once.

### Example 3

Virulence (Freeze-Dried Product)

This example demonstrates that the formulations with coated spores in an oil carrier can be highly virulent to a target pest. Submerged spores were lyophilized with three different aqueous solutions: 10% skim milk and 1% glycerol; 10% Curan 100™ and 1% glycerol; and 10% Ultrazine™ and 1% glycerol as described in Example 1. Aerial conidia, which were used as a reference in this experiment, were harvested from 20-day old plate cultures on Paris medium. The inoculum concentration of submerged spores for the three coated-spore treatments was determined by weighing a mass of lyophilized material having a known concentration of spores per gram. Concentration of aerial conidia was determined by direct counting with a hemacytometer. All inoculum suspensions were made in 70% diesel fuel : 30% peanut oil as a carrier. Controls insects were exposed to the carrier only.

The percent germination of each inoculum was measured by observing 200 spores at a concentration of approximately 1×10⁶ spores/mL in 70% diesel fuel: 30% peanut oil on semi-synthetic medium after 24 hr of incubation at 24° C. According to the amount of viable spores, stock formulated suspensions consisted of milk-coated spores titrated at 4.2×10⁸ spores/mL, Curan 100™-coated spores were titrated at 5.1×10⁸ spores/mL, Ultrazine™-coated spores were titrated at 3.9×10⁸ spores/mL, and crude aerial conidia were titrated at 4.8×10⁸ spores/mL. The stock concentrations were the highest doses used for the bioassay, and 1:10 serial dilutions of the stock concentration were used for the three lower doses. Each formulation was tested at four doses ranging from 0.8×10³ to 0.8×10⁶ spores/insect for both milk- and Ultrazine™-coated submerged spores, and from 1.0×10³ to 1.0×10⁶ spores/insect for both Curan 100™-coated submerged spores and crude aerial conidia

Bioassays were performed on approximately 8-day old Schistocerca gregaria (African desert locust) adults. Groups of 10 adults with a sex ratio of approximately 1:1 were treated with 2 μL of formulated inoculum using topical application with a micropipette directly under the pronotal shield. Treatment groups of 10 adults were contained in wire cages (27 cm×19 cm×13 cm) and maintained at 28° C., 43% relative humidity and a light:dark regime of 12h:12h (L:D) in individual controlled-humidity chambers. Relative humidity was maintained at 43%. Relative humidity was monitored within each test chamber with a probe attached to a data logger. Locusts were provided with a constant supply of fresh wheat bran and cages were replenished with fresh wheat seedlings daily. Locust mortality was determined daily. Dying locusts in this bioassay demonstrated characteristic signs of Metarhizium infection; they moved to the top of the cage, exhibited paralysis, and turned red. In addition, feeding appeared to stop approximately 24 to 48 hr before death.

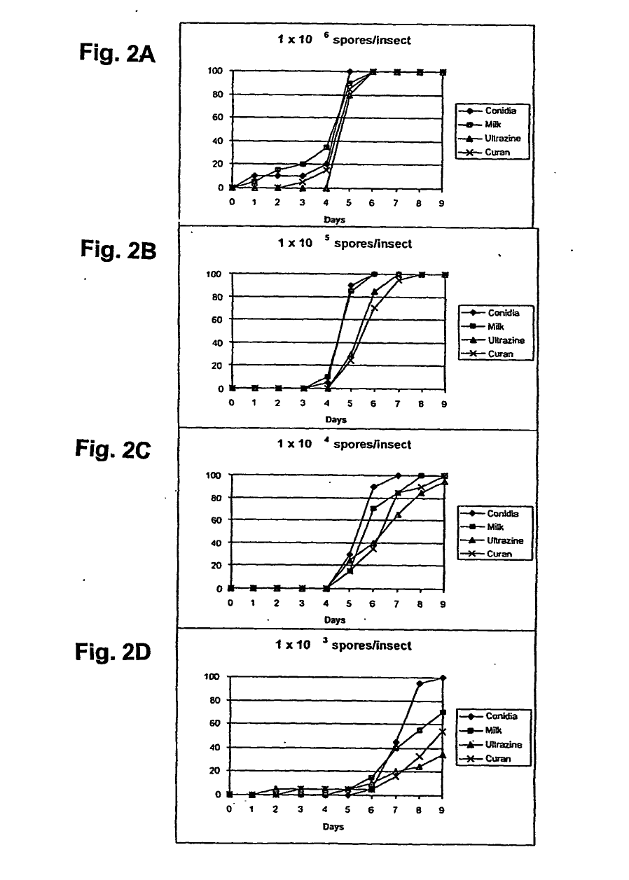

The results of this experiment are provided in FIGS. 2A-D. The virulence of the lyophilized, protected spores is similar to that of fresh Aerial conidia, especially at higher doses. This example demonstrates that formulations of a bioactive agent as described in the present invention protect the agent from UV damage so that the agent retains its effectiveness.

### Example 4

Microbe Viability during Production of Formulation (Coating by Air-Drying)

Spores of M. anisopliae var. acridum were produced in liquid shake flask culture in 4% waste brewers' yeast (Strohs Batch, NPC, Inc, Eden, N.C., USA): 4% Sucrose (Sigma) (Jenkins and Prior, 1993). Spores were from a 6 day old culture that was grown at 24° C. and agitated at 150 RPM in eight 250 mL baffled flasks. Spores of M. anisopliae var. acridum were also produced in aerial plate culture on Sabouraud Dextrose Agar in plate culture. Final concentration of spores ranged from 4.2×10⁸ spores/mL to 6.6×10⁸ spores/mL as determined by hemacytometer counting. Plates were grown at 24° C. and had sporulated within 2 to 3 weeks. A suspension of aerial conidia was made at 7.4×10⁸ spores/mL in 0.05% Tween 80.

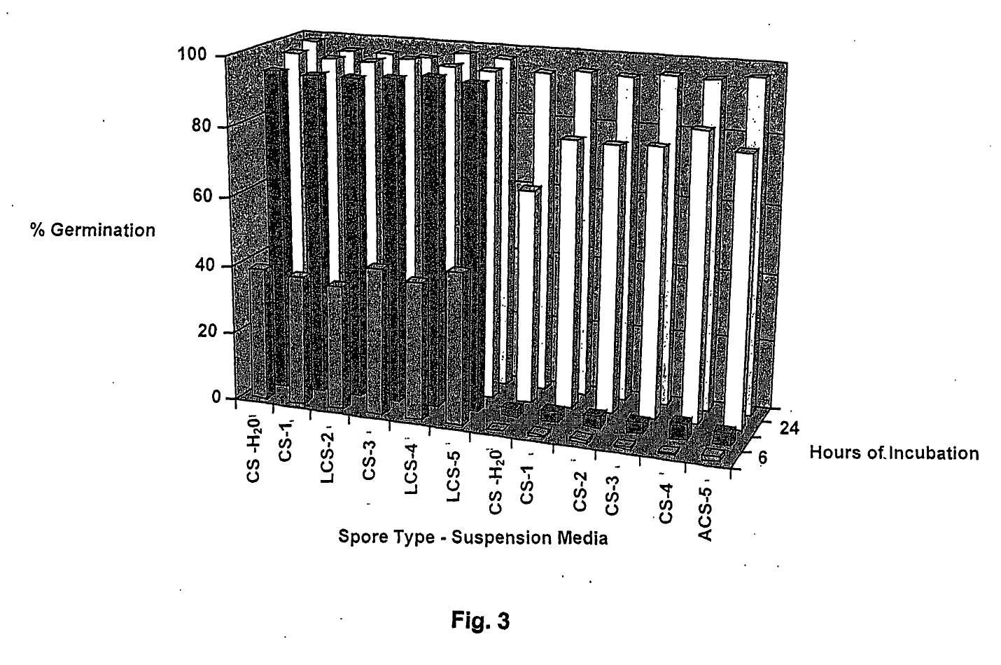

Both spore types [liquid-culture spores (LCS) and aerial-culture spores (ACS)] were washed three times by centrifugation and resuspending in sterile distilled water (2800×G, Fisher Scientific Marathon 6K centrifuge). Liquid-culture spores and aerial culture spores were then suspended in various suspension media containing a combination of the following coating materials: a water soluble lignin Curan 100™ (CUR), glycerol (GLY), skim milk (SM), and Sucrose (SUC) as described in Table 5. The % of spores that germinated over time was determined for each of the liquid-culture spores and aerial-culture spores (FIG. 3) in each of the 5 suspension media by observing a least 200 spores at 400× magnification on 2% malt agar+0.001% Benelate after incubating at 24° C. A 30-mL sample of approximately 2×10⁶ spores/mL was spread onto a 30 mm Petri plate. Germination was stopped with 20% fornalin and plates were stored at 4° C. until % germination was determined. A spore was considered to be germinated if the germ tube was greater than half the diameter of the spore.

TABLE 5
Suspension media used to coat liquid spores (LCS)
and aerial spores (ACS) during air drying and final
dry mass ratio of spores to various coating materials.

| Test | Suspension Media | |
|---|---|---|
| Group | Mass of coating to volume of water) | Dry Mass Ratio¹ |
| 1 | 10% CUR:0.25% GLY | 1:1:0.025 |
| | | SP:CUR:GLY |
| 2 | 10% CUR:1% GLY | 1:1:0.1 |
| | | SP:CUR:GLY |
| 3 | 10% CUR:1.25% SUC:1% GLY | 1:1:0.1 |
| | | SP:CUR:GLY |
| 4 | 5% CUR:5% SM:1.25% SUC:1% | 1:0.5:0.5:0.125:0.1 |
| | GLY | SP:CUR:SM:SUC:GLY |
| 5 | 5% CUR:5% SM:1% GLY | 1:0.5:0.5:0.1 |
| | | SP:CUR:SM:GLY |
| ¹Dry mass ratio is based on the estimated dry mass of spores from liquid culture using an approximate 70% moisture of the pellet after washing. The addition of suspension media to aerial conidia was calculated to produce a product that had the same number of spores/g of coating material but not the same dry mass ratio. The concentrations of spores in the formulations of liquid-culture spores and aerial-culture spores were approximately 5 × 10⁹ spores/g and | | |
| # 9 × 10⁹ spores/g of total formulation, respectively. | | |

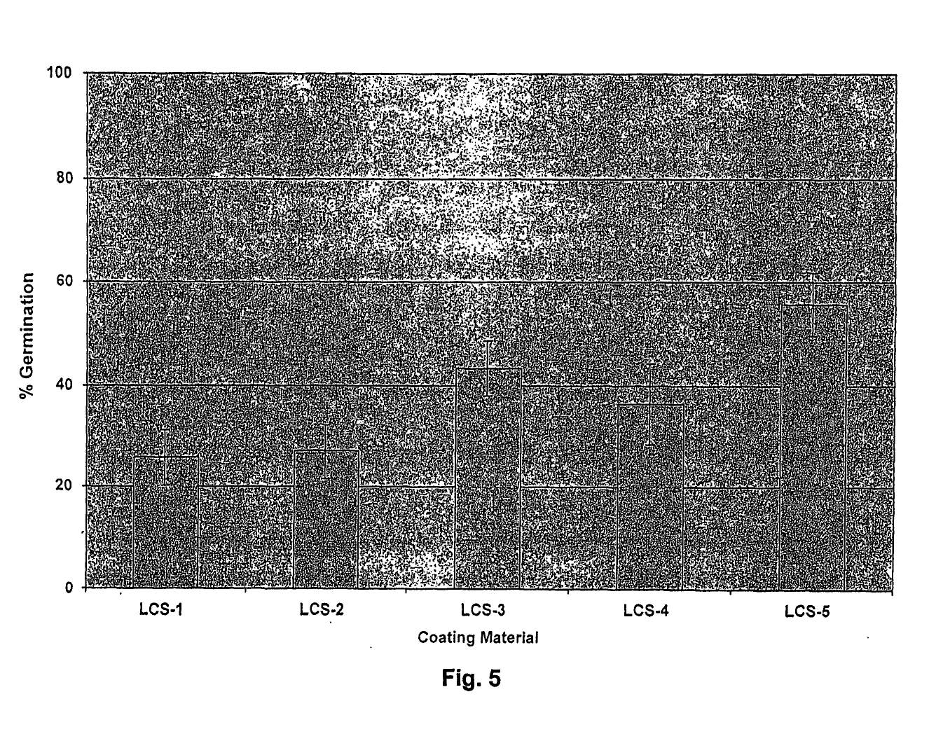

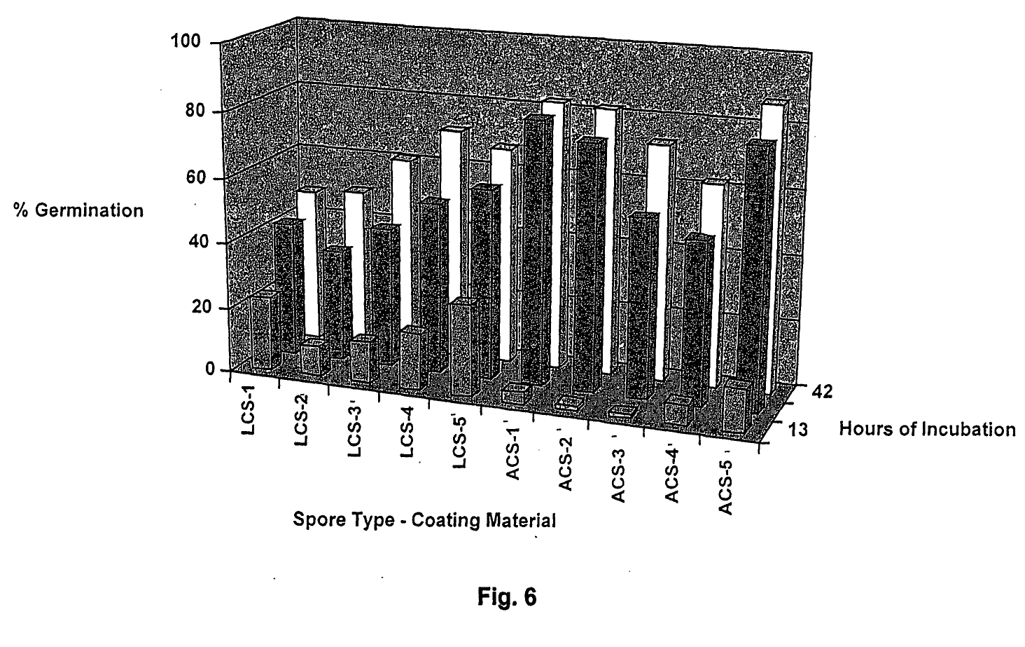

For each of the liquid-culture spore treatments, 4.5 mL of spore suspension was delivered to a 60 mm sterile Petri plate, and each treatment was replicated 4 times. For each of the aerial-culture spore treatments, 1.3 mL of spore suspension was delivered to a 30 mm sterile Petri plate, and each treatment was replicated 3 times. The % moisture of the spore suspensions were determined by change in mass after heating at 100° C. for 24 hours. The mass of material delivered to each Petri plate was determined in order to determine change in % moisture during the air drying process. The suspended spore samples were dried at ambient (30 to 60%) relative humidity in a laminar flow hood for 82 hr. The coated spores were then transferred to a desiccation chamber containing silica gel for an additional 56 hours of drying. The % germination of spores over time was determined for each of the treatments after the drying process. All dry coated-spore samples were rehydrated in a 100% relative humidity environment before suspending in distilled water and spreading on 2% malt agar±0.01% Benelate for determining % germination. The method for determining % germination is described above. A sample of the coated spores were then ground against the surface of a 170 openings per linear inch sieve using a glass rod. The % germination of spores over time was determined for the LCS treatments after the sieving process (FIG. 5). Samples of non-sieved material were stored at 28° C. for 6 days. The % germination of spores over time was determined for each of the treatments after the storing at 28° C. for 6 days (FIG. 6).

This example demonstrates that a biological bioactive agent remains viable during an air drying process resulting in coating with a protective material as described in the instant invention, and that the agent is present in useful quantities in the dried, protective material.

### Example 5

UV Protection (Air-Dried Product)

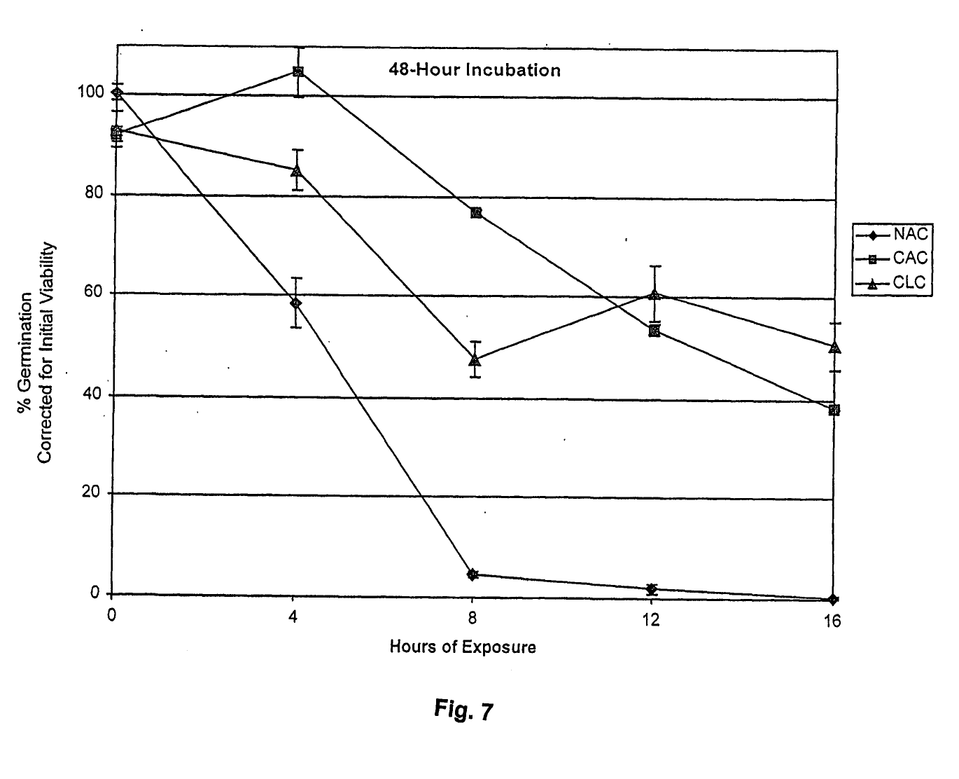

This example demonstrates that the formulations with coated spores from air drying in an oil carrier protect spores from damage by UV radiation. The sieved product from the liquid-culture spore and aerial-culture spores treatments corresponding to suspension media number 5 (1:0.5:0.5:0.1 Spores: Curan 100™:Skim Milk:Glycerol; dry mass ratios) in Example 4 were used in this example. Coated spores from liquid culture (CLC) and from aerial culture (CAC) were compared to non-coated spores from aerial culture (NAC) with respect to tolerance to UV light when suspended in an oil formulation. The methods for exposing spores to simulated sunlight was identical to that described in Example 2: UV Protection (Freeze-Dried Product). The percent germination following exposure to various time intervals of simulated sunlight is presented in FIG. 7. Only one membrane filter from each treatment was exposed for each time interval. The experiment was repeated using only the 0 hr and 16 hr exposure times with four replicates of each spore type and exposure time. This data is presented in Table 6.

TABLE 6
% Germination Before and After Exposure to UV

| | % Germination Before | % Germination After |
|---|---|---|
| Treatment | Exposure to UV (in oil)¹ | 16 hr of UV Exposure¹ |
| Non-coated aerial | 96 ± 2 | 6 ± 1 |
| culture | | |
| Coated aerial culture | 106 ± 8 | 62 ± 11 |
| Coated liquid culture | 95 ± 4 | 66 ± 3 |

¹Germination before exposure refers to spores that were resuspended from the filter membrane with water after being after being deposited with a 70% diesel fuel: 30% peanut oil carrier. Values in this table are corrected for initial viability, which was determined for the spore types suspended directly in water.

### Example 6

Virulence (Air-Dried Product)

This example demonstrates that the formulations with coated spores from air drying in an oil carrier can be highly virulent to a target pest. The sieved product from the liquid-culture spore and aerial-culture spore treatments corresponding to suspension media number 5 (1:0.5:0.5:0.1 Spores:Curan 100™:Skim Milk:Glycerol; dry mass ratios) in Example 4 were used in this example. Coated spores from liquid culture (CLC) and from aerial culture (CAC) were compared to non-coated spores from aerial culture (NAC) with respect to virulence to the grasshopper Schistocerca americana when suspended in 70% diesel fuel: 30% peanut oil. Aerial conidia (NAC), which were used as a reference in this experiment, were harvested from 2 to 3 week old plate cultures on Sabouraud Dextrose Agar medium. The inoculum concentration of submerged spores for the three coated-spore treatments was determined by weighing a mass of air dried material having a known concentration of spores per gram. Concentrations of non-coated aerial culture spores were determined by direct counting with a hemacytometer. All inoculum suspensions were made in 70% diesel fuel : 30% peanut oil as a carrier. Control insects were exposed to the carrier only. The percent germination of each inoculum was measured by observing 200 spores at a concentration of approximately 1×10⁶ spores/mL in 70% diesel fuel: 30% peanut oil on semi-synthetic medium after 24 hr of incubation at 24° C. Based on the number of viable spores, the following spore concentrations were made for each of the three spore types: 5×10⁸, 5×10⁷, 5×10⁶, and 5×10⁵.

Bioassays were performed on 2 to 3 week-old Schistocerca americana adults. Groupss of 10 adults with a sex ratio of approximately 1:1 were treated with 2 μL of formulated inoculum using topical application with a micropipette directly under the pronotal shield. Treatment groups of 10 adults were contained individually in wire-screened cages (27 cm×19 cm×13 cm) and maintained at 32° C., 50±5% relative humidity and a light:dark regime of 14 h:10 h (L:D). Relative humidity was maintained at 50%. Locusts were provided with a constant supply of romaine lettuce and cages were replenished daily. Locust mortality was determined daily. Dying locusts in this bioassay demonstrated characteristic signs of Metarhizium infection; they exhibited paralysis and turned red.

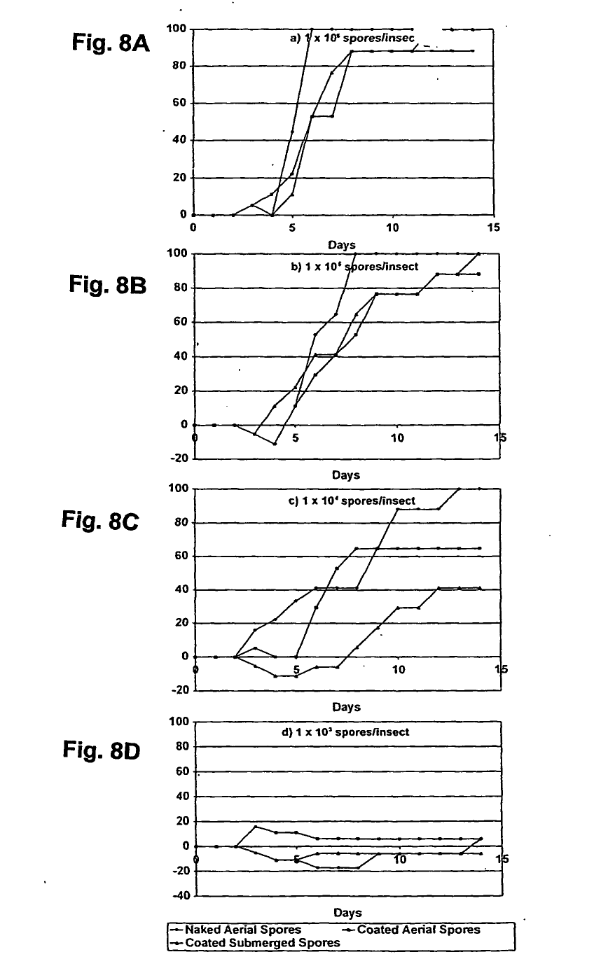

The results of this experiment are provided in FIGS. 8A-D. As can be seen, the virulence of the lyophilized, protected spores is similar to that of fresh aerial conidia, especially at higher doses. This example demonstrates that formulations of a bioactive agent as described in the present invention protect the agent from UV damage so that the agent retains its effectiveness.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

References

Bateman, R. P., Carey, M., Moore, D., and C. Prior. 1993. The Enhanced Infectivity of Metarhizium anisopliae var. acridum in oil formulations to Desert Locusts at Low Humidities. Ann. Appl. Biol. 122.145-152.

Brown, A. D. 1976. Microbial water stress. Bacterial Rev. 40: 803-846.

Burgess, H. D. 1998 Formulation of Microbial Biopesticides. Kluwer Acedemic Publishers. London, U.K. 412 pp.

Carpenter, J. F., and Crowe, J. H. 1988a Modes of stabilization of proteins by organic solutes during desiccation. Cryobiology. 25: 485-492.

Carpenter, J. F., and J. H. Crowe. 1988b. The mechanism of cryoprotection of proteins by solutes. Cryobiology. 25: 244-255.

Cooper W. J. and R. G. Zika. 1983. Photochemical formation of hydrogen peroxide in surface and ground waters exposed to sunlight Science 220: 711-712.

Crowe, J. H., Crowe, L. M., and D. Chapman. 1984. Preservation of membranes in anhydrobiotic organisms: the role of trehalose. Science. 223: 701-703.

Crowe, J. H., Carpenter, J. F., Crowe, L. M., and T. L. Anchordoguy. 1990. Are freezing and dehydration similar stress vectors? A comparison of modes of interaction of stabilizing solutes with biomolecules. Cryobiology. 27: 219-231.

Hunt, T. R., Moore, D., Higgins, P. M., and C. Prior. 1994. Effect of sunscreens, irradiance and resting periods on the germination of Metarhizium flavoviride conidia Entomophaga. V 39 (¾): 313-322.

Ignoffo, C. M., and C. Garcia 1978. UV-photoinactivation of cells and spores of Bacillus thuringiensis and effects of peroxidase on inactivation. Environ Entomol. 7 (2): 270-272n.

Ignoffo, C. M., and C. Garcia. 1994. Antioxidant and enzyme effects on the inactivation of inclusion bodies of the Heliothis baculovirus by simulated sunlight-TV. Environ Entomol. 23:1025-1029.

Jenkins, N. E. and C. Prior. 1993. Growth and formation of true conidia by Metarhizium flavoviride ina simple liquid medium. Mycological Research. 97: 1489-1494. (QK600 B6)

Kpindou, Douro O. K., J. Langewald, C. J. Lomer, H. van der Paauw, P. A. Shah, A. Sidibe. 1997. Field trails conducted on a biopesticide (Metarhizium anisopliae var. acridum) for grasshopper control in Mali from 1992 to 1994. Krall, S.; R. Peveling; D. Ba Diallo eds. New strategies in locust control. Basel, Switzerland. Birkhauser Verlag.

Lensen, Andrew. 1999 Quarterly Report May 1, 1999 to Jul. 31, 1999. Implementing Biological Control in Madagascar: A Bridge to Commercialization and Use. Report to USAID.

Lomer, C., Langewald, J. and Affa, P. (1997) Green Muscle User Handbook Biological and Grasshopper Control Project.

McClatchie, G., Moore, D., Bateman, R. P., and C. Prior. 1994. Effects of temperature on the viability of the conidia of Metarhizium anisopliae var. acridum in oil formulations. Mycol. Res. 98: 749-756.

Prior, C, Jollands, P, and G. le Patourel. 1988. Infectivity of oil and water formulations of Beauveria bassiana (Deuteromycotina: Hyphomycetes) to cocoa weevil pest Pantorhytes plutus (Coleoptera: Curculionidae). J. Invert. Pathol. 52: 66-72.

We claim:

1. A formulation comprising,
a bioactive agent coated with water-soluble protective material, and
a hydrophobic carrier.

2. The formulation of claim 1 wherein said bioactive agent is selected from the group consisting of biopesticidal microbes, viruses, nematodes, toxins, insect feeding inhibitors, pheromones, and insect growth regulators.

3. The formulation of claim 2 wherein said biopesticidal microbe is selected from the group consisting of viruses, fungi, bacteria, protozoa, and nematodes.

4. The formulation of claim 1 wherein said bioactive agent is a fungus.

5. The formulation of claim 1 wherein said water-soluble protective material is selected from the group consisting of UV protectants, sunblockers, and sunscreens.

6. The formulation of claim 5 wherein said UV protectant is a water-soluble lignin.

7. The formulation of claim 1 wherein said hydrophobic carrier comprises at least one oil.

8. The formulation of claim 7 wherein said hydrophobic carrier comprises diesel fuel and peanut oil.

9. The formulation of claim 1 further comprising a stabiliser.

10. The formulation of claim 9, wherein said stabilizer is selected from the group consisting of milk, non-reducing sugars, and biologically compatible solutes.

11. A method of producing a formulation for the protection of a bioactive agent comprising the steps of,
forming an aqueous mixture of said bioactive agent and a water-soluble protective material,
drying said mixture to form a dispersible mixture, and
suspending said dispersible mixture in a hydrophobic carrier.

12. The method of claim 11 wherein said bioactive agent is selected from the group consisting of biopesticidal microbes, viruses, nematodes, toxins, insect feeding inhibitors, pheromones, and insect growth regulators.

13. The method of claim 12 wherein said biopesticidal microbe is selected from the group consisting of viruses, fungi, bacteria, protozoa, and nematodes.

14. The method of claim 11 wherein said bioactive agent is a fungus.

15. The method of claim 11 wherein said water-soluble protective material is selected from the group consisting of UV protectants, sunblockers, and sunscreens.

16. The method of claim 15 wherein said UV protectant is a water-soluble lignin.

17. The method of claim 11 wherein said hydrophobic carrier comprises at least one oil.

18. The method of claim 17 wherein said hydrophobic carrier comprises diesel fuel and peanut oil.

19. The method of claim 11 wherein said formulation further comprises a stabiliser.

20. The method of claim 19, wherein said stabilizer is selected from the group consisting of milk, non-reducing sugars, and biologically compatible solutes.

21. A method of exposing a target substrate to a bioactive agent, comprising
contacting said target substrate with the formulation of claim 1.

22. The method of claim 21 wherein said target substrate is selected from the group consisting of insect pests, habitats of insect pests, plants, habitats of plants, disease producing organisms, and habitats of disease producing organisms.

23. The method of claim 21 wherein said bioactive agent is selected from the group consisting of biopesticidal microbes, viruses, nematodes, toxins, feeding inhibitors, pheromones, and insect growth regulators.

24. The method of claim 23 wherein said biopesticidal microbe is selected from the group consisting of viruses, fungi, bacteria, protozoa, and nematodes.

25. The method of claim 21 wherein said bioactive agent is a fungus.

26. An insecticide comprising
a bioactive agent specific for destroying insects, wherein said bioactive agent is coated with water-soluble protective material, and
a hydrophobic carrier.
